(19) United States
(12) Patent Application Publication
(10) Pub. No.: US 2018/0130042 A1
(43) Pub. Date: May 10, 2018

(54) POINT OF SALE ROUTER, SYSTEM AND METHOD

(71) Applicant: GoTab Inc., Vienna, VA (US)

(72) Inventor: Timothy L. McLaughlin, Vienna, VA (US)

(73) Assignee: GoTab Inc.

(21) Appl. No.: 15/344,827

(22) Filed: Nov. 7, 2016

(51) Int. Cl. G06Q 20/20

(52) U.S. Cl. CPC G06Q 20/209; G06Q 20/202

(57) ABSTRACT

Aspects of the present disclosure are directed to point of sale (“POS”) routers, system and methods that enable the access to and updating of internet-accessible customer accounts using existing conventional point of sale terminals. An exemplary POS router according to the disclosure is disposed between a POS terminal and a POS receipt printer. According to aspects of the disclosure, the POS router further includes a network interface to communicate with a customer account server via a network, in operation of a POS router according to one aspect of the disclosure receives signals from a POS terminal printer output and determines whether the digital information contained therein are of a first type intended to be routed to the POS receipt printer, or of a second type intended to be routed to the customer account server. Such POS router then routes such information accordingly.

### TECHNICAL FIELD

This disclosure relates generally to point of sale (“POS”) devices and more specifically, to POS routers useable with POS terminals and POS printers by which a POS terminal printer output port is advantageously used to convey information for printing as well as information intended for routing to a computer service, which is not intended for printing.

### BACKGROUND

Conventional POS systems are used to enter and record transactions of purchased items typically in the retail, wholesale and hospitality establishments. Such POS systems typically include a computer-controlled cash register (that enables entry of items to be purchased either by a bar code reader or key entry by a POS operator), a display, and associated devices, such as POS receipt printers and often credit card readers. In larger establishments, it is common for POS systems to be linked to a central computer database that maintains and updates item pricing, and records of transactions executed by the respective POS systems.

In order to provide a convenience and to take advantage of customers' growing use and reliance on the internet, establishments have enabled customers to create and access on-line loyalty and other accounts with the establishments to, amongst other things, track their purchases. In certain industries, such as the hospitality industry, e.g., restaurants and hotels, customers are able to maintain a tab and pay for purchases via their customer account using their smart phone or computer tablet, instead of the POS terminal. In order to provide this type of payment service, establishments have maintained online customer accounts on internet-accessible computers.

Presently the interaction between the computers maintaining the customer accounts and the establishment's POS systems are very complex and rely on high cost POS terminals, computer database servers and associated software. Such systems are often too expensive for many medium-sized and smaller establishments. A need in the industry exists to provide the internet-accessible customer account and loyalty account options including payment options using, via the internet, low-cost or existing POS terminals, without the need to replace such terminals with newer and more complex terminals and systems.

### SUMMARY

Aspects of the present disclosure are directed to the use of an advantageous POS router disposed between POS terminals and POS receipt printers. According to aspects of the disclosure, the POS router further includes a network interface to communicate with a customer account server via a network. In operation of an embodiment of the invention, the POS router receives signals from a POS terminal printer output and determines whether the digital information contained therein are of a first type intended to be routed to a POS receipt printer, or of a second type intended to be routed to the customer account server. Optionally, information of the first type may additionally be routed to the customer account server.

The invention is based, in part, on the inventor's discovery that many conventional POS terminals can be programmed to cleverly use the printer output port contained therein to transmit information other than receipt printer information. The inventor exploited such discovery by creating the POS router to identify which signals produced at the POS terminals printer output port should be routed to the POS receipt printer or elsewhere, such as, for example, to a network-connected., e.g., internet-connected, customer account server. The inventor further recognized that such other information may be useable by the customer account server, which could provide a variety of services for customers. In one aspect of the disclosure, the customer account server may, for example, provide updating of purchase items or services information in customer accounts and options for a customer to use her/his network-enabled device to pay for a present transaction without the need of a POS operator to complete the transaction payment via a POS terminal. Thus, the printer output port is being used according to aspects of the present disclosure for a purpose, in part, not originally intended by the POS terminal manufacture.

In a POS system embodiment according to an aspect of the disclosure comprising a POS terminal, POS receipt printer and POS router, the POS router receives signals from a printer output port of the POS terminal The POS router then determines, based on the information contained in the signal, whether such information should be routed to the printer, customer account server, both or neither.

In accordance with another embodiment of the invention, the customer account server may send control signals to the POS router to print information generated by the customer account server, such as when a customer pays for a subject transaction by her/his customer account, or to modify information in printer signals generated by the POS terminal, and sending printer signals to the POS receipt printer containing such modified information.

POS routers in accordance with the disclosure may be manufactured at low cost, and enable the use of existing POS terminals without the need for costly replacement by more complex POS terminals.

The invention is particularly useful in establishments in the hospitality industry, e.g., restaurants and hotels, in which purchases are made over extended experiences, i.e., extended periods of time, by customers.

Methods for the POS router and system are also provided in the present disclosure.

This SUMMARY is provided to briefly identify some aspects of the present disclosure that are further described below in the DESCRIPTION. This SUMMARY is not intended to identify all key or essential features of the present disclosure nor is it intended to limit the scope of any claims.

The term “aspects” is to be read as “at least one aspect.” The aspects described above and other aspects of the present disclosure described herein are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 is an exemplary POS system according to an aspect of the present disclosure.

FIG. 2 is schematic diagram depicting an exemplary POS router according to another aspect of the present disclosure;

FIG. 3 is an exemplary method for the POS router of FIG. 2.

The illustrative embodiments are described more fully by the Figures and detailed description. The inventions may, however, be embodied in various forms and are not limited to specific embodiments described in the Figures and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

We now provide some non-limiting, illustrative examples that illustrate several operational aspects of various arrangements and alternative embodiments of the present disclosure.

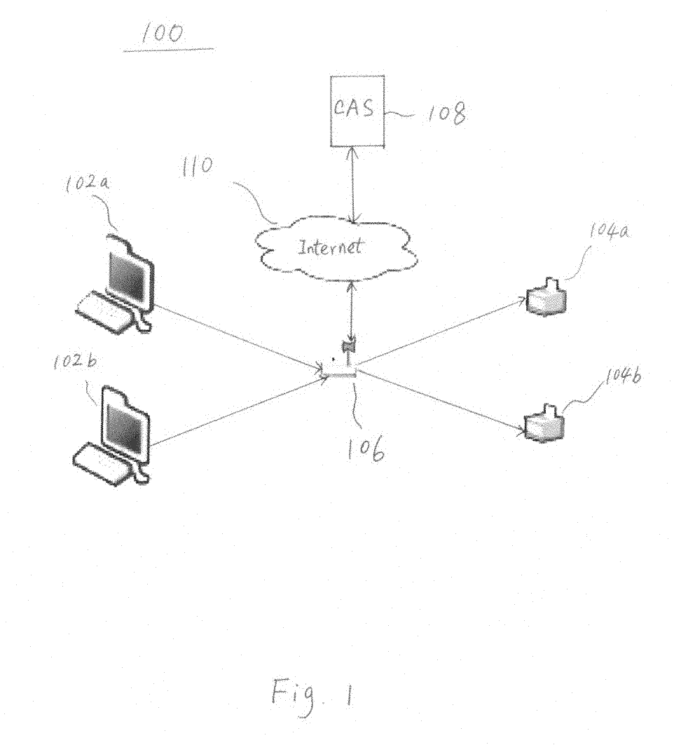

Aspects of the present disclosure are directed to the use of an advantageous POS router disposed between POS terminals and POS receipt printers. An exemplary POS system 100 according to an aspect of the present disclosure is shown in FIG. 1, which includes POS terminals 102a and 102b, and. POS receipt printers 104a and 104b, coupled to a POS router 106. Specifically, printer ports of the POS terminals 102a and 102b are coupled to the POS router 106. The POS router 106 further communicates with a customer account server (“CAS”) 108 via a network, such as the internet 110.

The invention is based, in part, on the inventor's discovery that many conventional POS terminals 102 can be programmed to cleverly use the printer output port contained therein to transmit information other than receipt printer information. The inventor exploited such discovery by creating the POS router to identify which signals produced at the POS terminals printer output port should be routed to the POS receipt printer or elsewhere as report signals to, for example, a network-connect, e.g., internet connected, CAS 108. The inventor further recognized that such other information may be useable by the CAS 108, which could provide a variety of services for customer account holders. Such services may include, for example, updating of purchase items or services information in customer accounts and options for a customer to use her/his wireless device, such as a Wi-Fi-enabled or internet-enabled device, to pay for a present transaction without the need of a POS operator to complete the transaction payment via a POS terminal 102a or 102b.

According to one aspect of the disclosure, the CAS 108 may, for example, provide updating of purchase items and/or services information in customer accounts and options for a customer to use her/his internet-enabled device to pay for a present transaction of purchased items and/or services without the need of a POS operator to complete the transaction payment via a POS terminal 102. Thus, in accordance with this disclosure, the printer output port is cleverly being used according to aspects of the present disclosure for a purpose, in part, not originally intended by the POS terminal manufacturer.

In operation of the POS system 100, one of the POS terminals 102a or 102b transmits a signal, via its printer output port to the POS router 106. It is possible to use any suitable format for the printer signal that a POS terminal is capable of transmitting. Suitable examples include, but are not limited to, ESC/POS® proprietary command language created by Epson, Printer Command Language (PCL) created by Hewlett Packard and PostScript created by Adobe. The POS router 106 then determines whether the digital information contained in the received signal is of a first type intended to be routed to one of the POS receipt printers 104a or 104b, or of a second type intended to he routed to the CAS 108 via the internet 110 and not to any of the POS receipt printers 104a or 104b. It is advantageous for the detected information of the first type to be transmitted to the POS receipt printers 104a and 104b in the same printer signal format, e.g., as that transmitted by a POS terminal 102a or 102b transmitting information to the POS router 106. In the alternative, the POS router 106 may translate and transmit the signals to one of the POS receipt printers 104a or 104b in a different format acceptable to such POS receipt printers 104a or 104b.

The information of the first type would include information to cause one of the printers 104a or 104b to print a receipt, ticket or other information specified by the POS terminal 102a or 102b. The second type of the information can include, for example, information denoting, purchased item identifiers, customer identifiers, customer account information, customer location, receipt identifiers, POS operator identifiers, time information, tax information and other transaction identifiers. As used herein, the information of the second type transmitted to the CAS 108 by the POS router 106 may, alternatively, be referred to as report signals.

In accordance with the disclosure, there are several ways for transmitted signals by the POS terminals 102a and 102b to denote whether such signals contain information of a first or second type. For example, a signal may contain digital control information located, for example, in a beginning portion of the signal that is a predetermined code indicating whether the signal contains information of a first or second type. Suitable examples of digital control information include having words or codes such as “PRINT” or “DO NOT PRINT” to indicate that the associated digital information in the signal is of a first or second type. Alternatively, the predetermined code may be positioned elsewhere in the signal including, for example, a trailing portion of the signal.

In another example, the POS router 106 may be programmed such that digital information in the signals transmitted by the POS terminals 102a and 102b, which are received by the POS router 106 as a result of a POS operator activating the print key of POS terminal 102a or 102b a single time, shall be considered information of the second type. Correspondingly, the POS rotor 106 may be additionally programmed such that information in signals transmitted by the POS terminals 102a and 102b to the POS router 106 as a result of a POS operator activating the print key twice, for example, within a predetermined time interval, such as less than 10 seconds, shall be considered information of the first type. Optionally, the POS router 106 may be programmed to, by default, transmit detected information of the information of the first type to the CAS 108 in addition to transmitting such information to one the POS receipt printers 104a and 104b.

In a further embodiment, if the POS router 106 determines that a received signal contains information of the second type, the POS router 106 may, optionally, transmit control signals to either of the POS receipt printers 104a or 104b to beep or cut paper (thereby producing an audible indicator) to confirm to the POS operator that digital information of the second type has been received and forwarded to the CAS 108. Alternatively, the POS router 106 may confirm such a receipt by, for example, producing a sound, vibration or providing a visual indication of signal, through an attached light, sound or vibration generator, or display screen.

The POS terminals 102a and 102b may be programmed to generate signals that contain control digital information, which the POS router 106 may analyze and determine if the associated digital information should be routed to a specific one of the POS receipt printers 104a or 104b. In accordance with another embodiment, the POS router 106 may alternatively determine which POS receipt printer, 104a or 104b, it should transmit the received digital information of a first type by examining the source the received signal, based upon predetermined configuration or programming of the POS router 106. Alternatively, similar rules for Ethernet routing may be employed by the POS terminals 102a and 102b and the POS router 106 for routing received digital information accordingly. Specifically, the terminals 102a and 102b, and the POS router 106 may use control digital information containing predetermined routing addresses assigned to respective POS receipt printers 104a and 104b, in a similar way to the routing of packets by systems compliant with the TCP/IP protocol. In such manner, the POS router 106 operates in manner similar to an Ethernet gateway, or uses network address translation (NAT) and acts as an Ethernet firewall or TCP proxy for the printer network.

The interaction between the CAS 108 and the POS router 106 will now be discussed in detail. In one aspect of the disclosure, upon receipt by the CAS 108 of information of the second type, such information is buffered in memory and/or stored in a database (not shown) within or associated with the CAS 108 for further analysis and processing by the CAS 108. Such analysis and processing by the CAS 108 may include, for example, enabling a customer to pay and/or provide real-time ratings and reviews of purchased items identified in the received information of the second type. Payment and/or real-time reviews may be made by a customer using, for example, a wireless network-accessible, e.g., Wi-Fi internet-accessible device, such as a smart phone, personal tablet computer or laptop, via a software application (App) or web-browser. Such an application is particularly advantageous in extended customer experiences, such as at restaurants, bars, hotels, arcades, amusement parks, resorts, concert and sports stadiums and arenas, and the like.

The POS terminals 102a and 102b or a user interface device (not shown), for example, proximate one or both of the POS terminals 102a and 102b, may be used by an POS operator to send data to the CAS 108 to associates a new or existing customer with purchased items identified in digital information of the second type received from the POS router 106. The user interface device, for instance, can be a tablet computer such as an iPad, Android tablet, or other general purpose computer with a touchscreen or other convenient user interface. For example, in operation, upon receipt of the signal from the CAS 108 or the user interface, the POS router 106 can transmit command signals to one of the POS receipt printers 104 to print a chit containing a unique identifier, URL or shortened-URL, by which a customer could retrieve his/her receipt over the Internet for review or payment, or to provide ratings for the purchased items. The POS router 106 may receive and print information received from the customer account server 108 to provide a paper receipt of payment or other information. Similarly, the POS router 106 may receive signals from the CAS 108 instructing it to print provided information or modify prior to printing the first type of information received from the POS terminal 102a or 102b for a particular customer or customers.

As another example, the POS router 106 can determine if the information intended for a receipt to be printed has previously been received or not, based on the check number and current date, and if not, subsequently print the aforementioned chit along with or instead of a receipt.

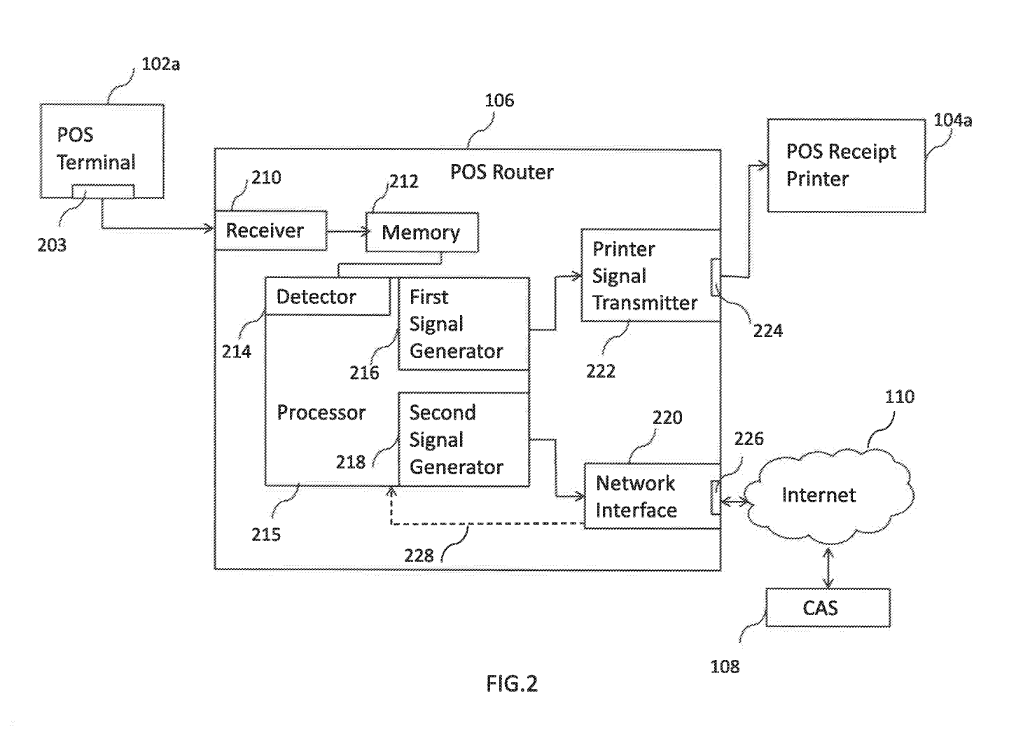

Aspects of the present disclosure can be implemented by using dedicated hardware as well as hardware capable of executing software in association with appropriate software. FIG. 2 depicts an exemplary hardware implementation useable for the POS router 106. Identical or similar components in FIGS. 1 and 2 are like numbered for ease of understanding including, for example, the POS router 106, and POS terminal 102a, POS printer 104a and internet 110. For illustration purposes, the POS router 106 is placed between a single POS terminal 102a and a single POS receipt printer 104a. However, the POS router 106 may also be coupled to and operate with a plurality POS terminals and POS receipt printers in accordance with the disclosure. The POS router 106 may also be integrated into a POS receipt printer.

Referring to FIG. 2, the POS router 106 includes a receiver 210 configured to receive signals from a printer output port 203 of the POS terminal 102a. The receiver 210 is further connected to a buffer or memory 212, which stores or buffers digital information in a received signal. The memory 212 is further coupled to a processor 215. The processor 215 includes a detector 214 to detect the presence of the first type or second type of information in digital information stored or buffered in the memory 212. The processor 215 further includes a first signal generator 216 to generate a print signal corresponding to information of the first type, and a second signal generator 218 to generate a report signal corresponding to information of the second type.

The processor's first signal generator 216 is coupled to a printer signal transmitter 222, which provides or is connected to a printer port 224 of the POS router 206. The printer port 224 can be coupled to a POS printer, such as POS printer 104a. The second signal generator 218 of the processor 215 is coupled to a network interface 220, which provides or is connected to a network port 226 of the POS router 106. The network port 226 can be coupled to the CAS 108 via a local area network or a wide area network (not shown), such as the internet 110. The network interface 220 optionally includes a control signal link 228 to the processor 215 to enable control signals transmitted by the CAS 108 to be received by the processor 215 via the network interface 220 and control signal link 228.

The processor 215 executes instructions in the form of software program(s) stored in firmware or memory (not shown) within or accessible by the processor 215. The detector 214 and first and second signal generators 216 and 218 of the processor 215 may be implemented in hardware and/or software. Moreover, the configuration of the POS router 106 in FIG. 2 is for ease illustration and it should be readily understood that the various components may be separated or grouped differently than that depicted in FIG. 2. For example, the detector 214 may be implemented separately from the processor 215. Likewise, the signal generators 216 and 218 may be implemented as stand-alone components or incorporated into the printer signal transmitter 222 and network interface 220.

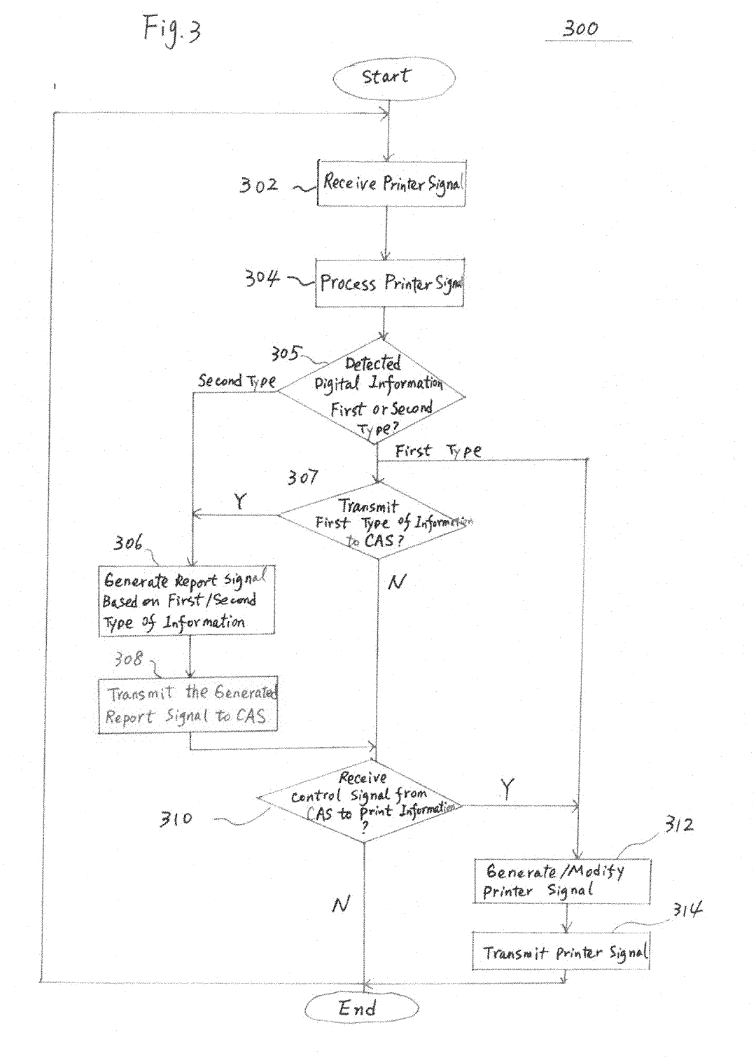

An exemplary process 300 of an operation of the POS router 106 is shown in FIG. 3 according to an aspect of the present disclosure. The following describes the process 300 with reference to the FIGS. 1 and 2. In FIG. 3, the process 300 begins with step 302 in which, for example, the receiver 210 of the POS router 106 receives a printer signal from the POS terminal 102a. In step 304, the receiver 210 provides the digital information to the memory 212 and such digital information stored in the memory 212 is processed, e.g., analyzed, to detect whether such digital information is of the first or second type.

Then, in decision step 305, if the detected digital information is of the first type, the process 300 proceeds to both steps 307 and 312, and if the digital information is of the second type, the process 300 proceeds to steps 306. If the detected digital information is of the first type, then (a) in step 312, the first signal generator 216 of the processor 106 transmits the detected digital information of the first type to the printer signal transmitter 222 for transmission to the POS printer 104a as indicated in step 314; and (b) in step 307, the processor 215 determines if the detected digital information of the first type should also be transmitted to the CAS 108. If in step 307, the processor 215 determines that the digital information should be additionally transmitted to the CAS 108, then process 300 proceeds to step 306 and if not, the process 300 proceeds to step 310.

In step 306, second signal generator 218 of the processor 215 generates and provides to the network interface 220, a signal based on the detected first or second type of the information. Then, in step 308, the network interface 220 of the POS router 106 transmits this signal to the CAS 108. The process then proceeds to step 310.

In step 310, the processor 215 of the POS router 106 can determine if control signals are received from the CAS 108 to generate or modify (or inhibit) a printer signal at step 312 for printing by 314, respectively. Whether or not such a control signals are received in step 310, the process 300 then proceeds back to step 302 and awaits receipt of further signals from the POS terminal 102a, and the repeats the process 300.

A more detailed implementation of the present disclosure can be discussed below: The POS router of the present disclosure, for example, can be implemented on a commercially available low-power, single-board ARM-based device running a Linux operating system, or any low cost general purpose computer. The POS router may have a multitude of physical input and output interfaces, including, but not limited to, serial (9- and 25-pin RS-232), parallel, Universal Serial Bus (USE), wired Ethernet (RJ45), wireless Ethernet (Wi-Fi), Bluetooth (Classic or BLE), Near Field Communications (NFC) or others. The POS router is configured to receive and transmit data using any combination of the available physical interfaces. For example, the POS router may be configured to receive print signals on a serial input interface, to transmit print signals to an attached POS printer on a different serial interface, or to transmit data to a CAS, over a wireless Ethernet (Wi-Fi) interface. As an alternative, the POS router may be configured to receive print signals on an on-board wired Ethernet interface, to transmit print signals to an attached POS printer on a separate wired Ethernet interface, or to transmit data to a remote data collection server over the input Ethernet interface, among other possible configurations.

The POS router may he configured to meet the local installation requirements by user settings to a website hosted on the POS router, or by the directly attached interface. This process is performed in “configuration mode,” which is the default mode for the POS router when it cannot connect to the Internet. In “configuration mode,” the POS router runs a lightweight web server, such as NGINX or Lighthttpd, which is available over the wired and wireless Ethernet interfaces, or through the directly attached interface. A user configuring the POS router for the local installation environment may connect to the wireless access point broadcasted by the POS router or the wired Ethernet port, and uses a web browser on an Internet-enabled device (such as laptop computer, desktop computer, tablet or mobile phone) to navigate to the configuration website hosted on the POS router. Through this website, the user supplies the necessary settings, including authentication credentials for wireless networks, to allow the POS router to access the Internet (Wi-Fi or wired Ethernet).

On completing of the configuration process, the POS router stores the user inputted settings to configuration files and attempts to connect to the Internet using the settings entered by the user. If connectivity is successfully established, the POS router connects to a remote provisioning server, supplies POS router details, and downloads firmware updates and additional configuration parameters, such as the unique identifier for the installation location, parameters for check parsing, the destination endpoint for data transmission, logging level and log transmission/rotation frequency. On completing the downloading, the POS router begins “run mode.” If it fails to connect to the remote provisioning server while in “run mode,” then the POS router restarts in “configuration mode.”

In “run mode,” the POS router is programmed to execute routing logic written in, for example, the Python programming language. After initial administrative configuration, the router program executes on startup and remains in memory for the duration of the POS router uptime. On startup, the router program establishes a link to a user-specified input interface to monitor print signals sent by an attached POS terminal, and also establishes a link to a user-specified output interface which is connected to a receipt printer. In the event that multiple physical interfaces exist for the user-specified preferred logical interface, the POS router initially establishes link to all such interfaces.

The first interface to receive an input signal is at that point identified as the unanibiguous input interface and all others that were previously monitored are released by the router program. For example, if multiple physical USB interfaces are available on the POS router, they are logically represented at the operating system level as sequentially-numbered files residing under the /dev directory (e.g. /dev/ttyUSB0, /dev/ttyUSB1, /dev/ttyUSB2 and so on). To disambiguate which of the filesystem-level representations of the physical interface was specified by the administrator during configuration, the router program on the POS router is attached to all the available filesystem representations of the interface, and the first one to receive an input signal is subsequently deemed to be the preferred input channel.

In the course of typical customer sales scenarios, for example, for a restaurant, a POS operator operating the POS terminal may enter orders as per the manufacturer-specified procedures. To complete order entry, the POS operator causes the POS terminal to issues a print command. The print command from the POS terminal is coded, for example, in the ESC/POS® printer language supported by most receipt printers, and is readily readable by software executing described in the present disclosure. By default, the POS router of the present disclosure will then only transmit the print signal and associated digital information to the customer account server without sending such information to the POS receipt printer. However, if the POS operator explicitly wants to route the print command to the POS receipt printer, he or she simply issues the print command on the POS terminal twice within a predetermined time interval. The POS router executing the software described in the present disclosure examines the incoming ESC/POS® print signal, and if it encounters the same print pattern within the predetermined time interval, it transmits the print command to the attached POS receipt printer. The POS router may also transmit the same digital information to be printed to the CAS.

All receipt processing activities and network transmission attempts are logged to files residing in memory on the POS router. The POS router may be programmed to periodically transmit the log files to a remote data collection server for long-term storage and to subsequently remove the transmitted files from the local filesystem to preserve available storage space on the POS router.

The following is exemplary Python software code useable by a POS router according to one aspect of the present disclosure.

#!/usr/bin/env python
import time, serial, os, sys, re, hashlib, logging, ConfigParser, socket. SocketServer, boto3,
multiprocessing
################# read configs from file and set vars #################
configfile = ‘./configs.txt’
config = ConfigParser.RawConfigParser(allow_no_value=True)
config.read(configfile) or sys.exit (“Can't find config file ====> ” + configfile)
OPERATIONMODE = config.get(‘Main Configs’,‘OPERATIONMODE’)
TESTMODE = config.getboolean(‘Main Configs’,‘TESTMODE’)
LOCATIONID = config.get(‘Main Configs’,‘LOCATIONID’)
STATIONID = config.get(‘Main Configs’,‘STATIONID’)
PRINTTIMEOUT = config.getint(‘Main Configs’,‘PRINTTIMEOUT’)
CHECKNUMREGEX = config-get(‘REGEX','checknumregex')
CCRECEIPTREGEX = config.get(‘REGEX’,‘ccreceiptregex’)
CLOCKINREGEX = config.get(‘REGEX’, ‘clockin’)
CHECKOUTREGEX = config.get(‘REGEX’,‘checkoutreport’)
DATETIMEREGEXITEMS = config.items(“DATETIMEREGEX”)
FORMATINGREGEXITEMS = config.items(“FORMATINGREGEX”)
AWSREGION = config.get(‘AWS’,‘region’)
S3BUCKETNAME = config.get(‘AWS’,‘s3bucketname’)
LOGFILE = config.get(‘Main Configs’,‘LOGFILE’)
LOGLEVEL = config.get(‘Main Configs’,‘LOGLEVEL’)
AWSLOGLEVEL = config.get(‘Main Configs’,‘AWSLOGLEVEL’)
LOGFORMAT =
logging.basicConfig(filename=LOGFILE,level=LOGLEVEL,format=config.get(‘Main
Configs’,‘LOGFORMAT’))
in_host = config.get(‘Comm Settings’,‘inputnethost’)
in_port = config.getint(‘Comm Settings’,‘inputnetport’)
out_host = config.get(‘Comm Settings’,‘outputnethost’)
out_port = config.getint(‘Comm Settings’,‘outputnetport’)
buzzcode = ‘@’ + chr(27) + chr(30) + chr(27) + chr(30)
#######################################################################
#### Shut up noisy AWS logging
logging.getLogger(‘boto3’).setLevel(AWSLOGLEVEL)
logging.getLogger(‘botocore’).setLevel(AWSLOGLEVEL)
logging.getLogger(‘nose’).setLevel(AWSLOGLEVEL)
logging.getLogger(‘s3transfer’).setLevel(AWSLOGLEVEL)
# Set some global stuff for use later on
global buffer, last_receipt, out_ser
buffer = ‘’
last_receipt = [ ]
out_ser = serial.Serial( )
# compile regex pattern for ESC/POS print initialization command
esc_ pattern = re.compile(‘\hat{ }-@’, re.UNICODE)
# compile regex pattern for ESC/POS paper cut command that signals end of receipt
cut_pattern = re.compile(‘.*V$’,re.UNICODE)
# compile regex pattern for string that identifies the check number
checknum_pattern = re.compile(CHECKNUMREGEX,re.MULTILINE | re.UNICODE)
# compile regex pattern for string that identifies a receipt as a credit card receipt
ccreceipt_pattern = re.compile(CCRECEIPTREGEX,re.MULTILINE | re.UNICODE)
# compile regex pattern for string that identifies a receipt as an employee clock-in/clock out
receipt
clockin_pattern = re.compile(CLOCKINREGEX,re.MULTILINE | re.UNICODE)
# compile regex pattern for string that identifies a receipt as a checkout report
checkout_pattern = re.compile(CHECKOUTREGEX,re.MULTILINE | re.UNICODE)
class TCPHandler(SocketServer.StreamRequestHandler):

def handle(self):

for line in self.rfile:

self.data = line
parseinput(self.data)

self.request.close( )

def initio (mode):

if mode == “serial”:

################## SERIAL SETTINGS ######################
# If script is used in serial mode...
# Define input port settings
in_ser = serial.Serial(
port=config.get(‘Comm Settings’,‘inputport’),
baudrate = config.get(‘Comm Settings’,‘inputbaudrate’),
parity=serial.PARITY_EVEN,
stopbits=serial.STOPBITS_ONE,
bytesize=serial.EIGHTBITS,
rtscts=config.getboolean(‘Comm Settings’,‘inputrtscts’),
timeout=config.get(‘Comm Settings’,‘inputtimeout’),
)
# Flush the buffer to clear out any preexisting data
in_ser.flush( );
# Define output port settings
global out_ser
out_ser= serial.Serial(
port=config-get(‘Comm Settings’,‘outputport’),
baudrate = config.get(‘Comm Settings’,‘outputbaudrate’),
parity=serial.PARITY_NONE,
stopbits=serial.STOPBITS_ONE,
bytesize==serial.EIGHTBITS,
dsrdtr=config.getboolean(‘Comm Settings’,‘outputdsrdtr’),
timeout=config.getint(‘Comm Settings‘,‘outputtimeout’),
)
while 1:

x=in_ser.readline( );
parseinput(x)

else:

if mode == “network”:

# Create the listener, binding to the configured host, and port
logging.info(“Starting listener bound to %s:%s”,in_host,in _port)
try:

listener = SocketServer.TCPServer((in_host, in_port),

TCPHandler)

# Activate the server; this will keep running until you
# interrupt the program with Ctrl-C
listener.serve_forever( )

except:

logging.info(“Shutting down listener on %s:%s”,in_host,in_port)

else:

logging,critical(“No operation mode specified. Exiting.”)
exit( )

def sendtoprinter (receipt):

if OPERATIONMODE == “serial”:

global out_ser
out_ser.write(receipt)

else:

if OPERATIONMODE == “network”:

try:

printsocket = socket.socket( )
printsocket.setsockopt(socket.SOL_SOCKET,

socket.SO_REUSEADDR, 1)

printsocket.connect((out_host, out_port))
printsocket.send(receipt)
printsocket.shutdown(socket.SHUT_RDWR)
printsocket.close( )

except:

logging.critical(“Unable to open socket to printer”)

else:

logging.critical(“Operation mode not set. Exiting.”)
exit(0)

return

def traasfer( receipt, filename ):

try:

awsclient = boto3.resource(‘s3’)
awsclient.Object(S3BUCKETNAME,filename).put(Body=receipt)
logging.info(“Successfully delivered receipt %s to AWS”,filename)

except:

logging.error(“Error delivering file %s to AWS”, filename)

finally:

return

def process_receipt( receipt, received_time ):

logging.info(“Beginning; receipt processing.”)
# Decode the byte stream to UTF-8 for string comparison
decoded=receipt.decode(“utf-8”)
unformatted = decoded
cc_match = ccreceipt_pattern.search(decoded)
clockin_match = clockin_patten.search(decoded)
checkout_match = checkout_pattern.search(decoded)
if (cc_match is None and clockin_match is None and checkout_match is None):

check_match = checknum_pattern.search(decoded)
if check_match is None:

#log the error
logging.error(“Could not extract check number from

receipt: %s”,decoded)

return 0

(checknum,checksplit)=check_match.group(1,2)
if checksplit is not None:

checknum = checknum + checksplit

logging.debug(“Extracted check number=%s from

receipt=%s”,checknum,decoded)

# Now let's remove the ESC/POS formatting codes
for key, val in FORMATTINGREGEXITEMS:

regexpatten = re.compile(val,re.MULTILINE | re.UNICODE |

re.IGNORECASE)

logging.debug(“Executing search & replace or pattern %s”, val)
unformatted = re.sub(regexpattem,‘’,unformatted)

decoded = unformatted
# Look through the receipt and temporarily remove any time/day stamp so we

can
# compare hashed values to know if it's the same receipt being printed twice

for key, val in DATETIMEREGEXITEMS:

regexpattern = re.compile(val,re.MULTILINE | re.UNICODE |

re.IGNORECASE)

logging.debug(“Executing search & replace on pattern %s”, val)
decoded = re.sub(regexpattern,‘’,decoded)

hashed_receipt = hashlib.md5(decoded)
hashdigest = hashed_receipt.hexdigest( )
logging.debug(“Digest value of hashed receipt=%s”,hashdigest)
# Now if we see the same check number within the configured timeout period,

assume it was meant to be printed

global last_receipt
if len(last_receipt) > 0:

delta = received_time-last_receipt[1]
logging.debug(“last_receipt[0]=%s and hashedigest=%s and

last_receipt[1]=%s”,last_receipt[0],hashdigest,last_receipt[1])

if (last_receipt[0] == hashdigest and last_receipt[1] >= received_time-

PRINTIMEOUT):

logging.debug(“Found match with last receipt.”)
logging.debug(“Timestamp of last receipt=%s”,last_receipt[1])
logging.debug(“Time delta between last receipt and current

receipt=%d seconds”,delta)

if TESTMODE != True:

logging.info(“Sending receipt to printer.”)
sendtoprinter(receipt)

else:

logging.debug(“In test mode. Skipping printing.”)

else:

if TESTMODE != True:

logging.info(“Time delta: %d. Suppressing print request

and sounding printer buzzer”,delta)

sendtoprinter(buzzcode)

else:

logging.debug(“In test mode. Skipping sounding printer

buzzer.”)

else:

logging.debg(“No previous receipt found.”)

logging.debug(“Setting last_receipt timestamp=%s”,received_time)
last_receipt = (hashdigest,received_time)
# Now generate a filename made up of location ID + station ID + check number

and send to listener

filename = LOCATIONID + ‘.’ + STATIONID + ‘.’ + checknum + ‘.’ + hashdigest

+ ‘.txt’

# Sometimes check numbers can have a / character, so we need to replace that

# with something else to avoid confusion with folder separators

regexpattern = re.compile/(‘/’,)
filename = re.sub(regexpatter,‘-’,filename)
p = multiprocessing.Process(target=transfer, args=(unformatted,filename,))
p.start( )

else:

logging.debug(“Skipping upload on receipt:\n%s”,decoded)
if TESTMODE != True:

logging.info(“Sending receipt to printer.”)
sendtoprinter(receipt)

else:

logging.debug(“In test mode. Skipping printing.”)

return

def parseinput (input):

# Need to decode byte stream to UTF-8 to do string comparison
decoded=input.decode(“utf-8”)
esc_match = esc_pattern.match_decoded)
cut_match = cut_patten.match(decoded)
# Look for printer init pattern match
if esc_match is not None:

logging.debug(“Found start of new receipt. esc_match=%s”,esc_{——}match)
global buffer
buffer += input

else:

# Look for paper cut pattern match
if cut_match is not None:

# If we find the cut command, assume we have a complete

receipt.

Append the last line of the receipt that we just read to the

buffer before processing

buffer += input
logging.debug(“Found end of receipt. Calling process_receipt

with buffer value=%s”,buffer)

process_receipt(buffer,time.time( ))
# Reset buffer
buffer = ‘’

else:

buffer += input

if _{——}name_{——} == ‘_{——}main_{——}’:

# Start listening...
logging.info(‘Starting operation’)
if OPERATIONMODE is not None:

logging.info(“Setting operation mode to %s”,OPERATIONMODE)
initio(OPERATIONMODE)
parseinput(‘’)

else:

logging.critical(“No operation mode specified. Exiting.”)
exit(0)

While we have presented this disclosure using some specific examples, those skilled in the art will recognize that our teachings are not so limited. Accordingly, this disclosure should be only limited by the scope of the claims attached hereto. For example, although the embodiments of the POS router described in detail with regard to FIG. 2 rely on the routing of the first and second types of information through the processor 215, it is possible for the POS router of the present disclosure to route such information via a rely or other router component under control of the processor 215.

1. A point of sale router comprising:
a receiver configured to receive a first printer signal in a first predetermined format from a point of sale terminal, the first printer signal comprising first and/or second types of information, the first type of information is intended for use by a point of sale printer and the second type of information is intended for use in reporting to a customer account server;
a transmitter configured to transmit a second printer signal in the first predetermined format to a point of sale printer;
a network interface configured to transmit a report signal in a second predetermined format to the customer account server; and
a processor coupled to the receiver and first transmitter and network interface;
said processor comprising:
a detector configured to process the received first printer signal and detect the presence of information of either the first or second type, and
first and second signal generators;
wherein, in response to the detector detecting the presence of the information of the second type information, the processor is configured to cause the second signal generator to generate the reporting signal based on the information of the second type for transmission via the network interface and inhibit the first generator from generating the second printer signals based on the information of the second type, and
wherein, in response to the detector detecting the first printer signal the presence of information in the first type, the processor is configured to cause the first signal generator to generate the second printer signal corresponding to at least a portion of the first printer signal.

2. The point of sale printer controller device of claim 1 further comprising a memory coupled to the processor to buffer the information in the received first printer signal, wherein said detector is configured to process the received first printer signal by analyzing the buffered information.

3. The point of sale router of claim 2 wherein the detector is configured to detect one or more predetermined identifiers in the buffered information to denote information of the first or second type.

4. The point of sale router of claim 1 comprising a relay coupled between the receiver and transmitter, and controlled by the processor, said processor switch being configured to cause the relay to direct the first printer signal to the transmitter in substantial absence of the detector detecting the presence of the second type of information.

5. The point of sale router of claim 1 wherein the network interface is configured to receive a control signal from the customer account server, to cause the second generator to either generate the second printer signal based on information provided in the control signal, or inhibit the first generator from generating the second printer signal.

6. The point of sale router of claim 1 wherein the first predetermined format corresponds to ESC/POS or ESC/P printer programming language.

7. The point of sale router of claim 1 wherein the information of the second type is selected from the group consisting of purchased item identifiers, customer identifiers, customer location, receipt identifier, POS operator identifier, time information, tax information customer account information and transaction identifiers,

8. The point of sale router of claim 1 wherein said router is disposed within the point of sale printer.

9. The point of sale router of claim 1 wherein the information of the first type is detected when the router receives an indicator that a POS operator issued an identical print command twice within a predetermined time interval.

10. The point of sale router of claim 1 wherein the information of the second type is detected when the information includes an indicator that a POS operator issued a print command once for the first printer signal.

11. The point of sale router of claim 1 wherein the processor is further configured to cause the second signal generator to generate the reporting signal based on the information of the first type.

12. An improved point of sale system comprising:
a point of sale terminal configured to generate a first printer signal in a first predetermined format, the first printer signal comprising first and second types of information, the first type of information is intended for use by a point of sale printer and the second type of information is intended for use in reporting to a customer account server;
a point of sale printer; and
a point of sale router coupled between the point of sale terminal and printer, the
point of sale router comprising:
a receiver configured to receive the first printer signal;
a transmitter configured to transmit a second printer signal in the first predetermined format to a point of sale printer;
a network interface configured to transmit a report signal in a second predetermined format to a customer account server; and
a processor coupled to the receiver, transmitter and network interface; said processor comprising:
a detector configured to process the received first printer signal and detect the presence of information of the first or second type signals, and
first and second signal generators;
wherein, in response to the detector detecting the presence of the information of the second type information, the processor is configured to cause the second signal generator to generate the reporting signal based on the information of the second type for transmission via the network interface and inhibit the first generator from generating the second printer signals based on the information of the second type, and
wherein, in response to the detector detecting in the first printer signal the presence of information in the first type, the processor is configured to cause the first signal generator to generate the second printer signal corresponding to the first printer signal.

13. The system of claim 12 wherein the point of sale router further comprises a memory coupled to the processor to buffer information in the received first printer signal, wherein said detector is configured to process the received first printer signal by detecting the buffered information.

14. The system of claim 12 wherein the detector is configured to detect a predetermined identifier in the buffered information to denote information of the first or second type.

15. The system of claim 12 comprising a relay coupled between the receiver and transmitter, and controlled by the processor, said processor being configured to cause the relay to direct the first printer signal to the transmitter in substantial absence of the detector detecting the presence of the information of the second type.

16. The system of claim 12 wherein the network interface is configured to receive a control signal from the customer account server to cause the second generator to either generate the second printer signal based on information provided in the control signal, or inhibit the first generator from generating the second printer signal.

17. The system of claim 12 wherein the first predetermined format corresponds to ESC/POS or ESC/P printer programming language.

18. The system of claim 12 wherein the information of the second type is selected from the group consisting of purchased item identifiers, customer identifiers, customer account information, customer location, receipt identifier, POS operator identifier, time information, tax information and transaction identifiers.

19. The system of claim 12 wherein the point of sale router is disposed within the point of sale printer.

20. The system of claim 12 wherein the information of the first type is detected when the information includes an indicator that a POS operator issued an identical print command twice within a predetermined time interval.

21. The system of claim 12 wherein the information of the second type is detected when the information includes an indicator that a POS operator issued a print command once for the first printer signal.

22. The system of claim 12 wherein the processor is further configured to cause the second signal generator to generate the reporting signal based on the information of the first type.

23. A method for a point of sale router, the method comprising the steps of:
receiving a first printer signal in a first predetermined format from a point of sale terminal, the first printer signal comprising first and/or second types of information, the first type of information is intended for use by a point of sale printer and the second type of information is not intended for use with a point of sale printer but for use in reporting to a customer account server;
processing the received first printer signal to detect the presence of information of the first or second type;
in response to the detection of the presence of the information of the first type, generating second printer signals corresponding to a first predetermined format of the first printer signal;
transmitting the second printer signals to a point of sale printer;
in response to the detection of the presence of the information of the second type, generating, based on the information, a reporting signal in a second predetermined format; and
transmitting the generated report signal to a customer account server.

24. The method of claim 23 further comprising the step of:
buffering information in the received first printer signal, wherein the detecting step is performed on the buffered information.

25. The method of claim 23 further comprising the step of:
generating the second printer signals as unmodified versions of the first printer signal in substantial absence of the processing step detecting the presence of the information of the second type in the buffered information.

26. The method of claim 23 wherein the processing step detects a predetermined identifier in the information in the first printer signal to denote information of the first or second type.

27. The method of claim 23 further comprising the steps of:
receiving a control signal from the customer account server; and
based on information provided in the control signal, either generating the second printer signal based on the information, or inhibit the generation and transmission of the second printer signal.

28. The method of claim 19 wherein the information of the second type is selected from the group consisting of purchased item identifiers, customer identifiers, customer account information, customer location, receipt identifier, POS operator identifier, time information, tax information and transaction identifiers.

29. The method of claim 19 wherein the processing step detects information of the first type when the information includes an indicator that a POS operator issued an identical print command twice within a predetermined time interval.

30. The method of claim 19 wherein the processing step detects information of the second type when the information includes an indicator that a POS operator issued a print command once for the first printer signal.

31. The method of claim 19 further comprising the step of, in response to the detection of the presence of the information of the first type, further transmitting such information to the customer account server.
